(19) United States
(12) Patent Application Publication
(10) Pub. No.: US 2010/0296994 A1
(43) Pub. Date: Nov. 25, 2010

(54) CATALYST AND METHOD FOR DISMUTATION OF HALOSILANES CONTAINING HYDROGEN

(75) Inventors: Hartwig Rauleder, Rheinfelden (DE); Ekkehard Mueh, Rheinfelden (DE); Reinhold Schork, Rheinfelden (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GMBH, ESSEN (DE)

(21) Appl. No.: 12/744,204

(22) PCT Filed: Oct. 8, 2008
(86) PCT No.: PCT/EP08/63461

§ 371 Date: May 21, 2010

(30) Foreign Application Priority Data
Dec. 6, 2007 (DE) 10 2007 059 170.7

(51) Int. Cl. C01B 33/107; B01J 19/00; C01B 33/04; B01J 29/04; B01J 31/02

(52) U.S. Cl. 423/342; 422/610; 423/347; 502/62; 502/158

(57) ABSTRACT

The invention relates to a catalyst, the use thereof, and a method for dismutation of halosilanes containing hydrogen, in particular chlorosilanes containing hydrogen.

The invention relates to a catalyst, to the use thereof, and to a process for dismutating hydrogen-containing halosilanes, especially hydrogen-containing chlorosilanes.

The dismutation reaction serves, for example, to prepare monosilane (SiH₄), monochlorosilane (ClSiH₃) and also dichlorosilane (DCS, H₂SiCl₂) from trichlorosilane (TCS, HSiCl₃) with formation of the silicon tetrachloride (STC, SiCl₄) coproduct.

The dismutation reaction to prepare less highly chlorinated silanes, such as monosilane, monochlorosilane or dichlorosilane, from more highly chlorinated silanes, generally trichlorosilane, is performed in the presence of catalysts to more rapidly establish the chemical equilibrium. This involves an exchange of hydrogen and chlorine atoms between two silane molecules, generally according to the general reaction equation (1), in a so-called dismutation or disproportionation reaction. x here may assume the values of 1 to 3.

2HₓSiCl₄₋ₓ→Hₓ₊₁SiCl₄₋ₓ₋₁+Hₓ₋₁SiCl₄₋ₓ₊₁ (1)

It is customary to disproportionate trichlorosilane over suitable catalysts to give dichlorosilane with removal of silicon tetrachloride. This is an equilibrium reaction whose equilibrium is established only slowly. The majority of the catalysts used are secondary and tertiary amines, or quaternary ammonium salts (cf. DE-B 21 62 537). In order to accelerate the establishment of the equilibrium and not to reach excessively long residence times over the catalyst bed and in the reactor, high temperatures and high pressures are employed. Working under pressure, however, increases the fire risk in the event of a leak, since dichlorosilane and any proportions of H₃SiCl or SiH₄ formed are self-igniting in the presence of oxygen. In flow reactors, the proportion of unconverted trichlorosilane is very high. The trichlorosilane must be passed through and redistilled several times with high energy expenditure before a full conversion is finally achieved.

A further example of the reaction according to equation (1) is the preparation of dichlorosilane from trichlorosilane according to EP 0 285 937 A1. A process is disclosed there for preparing dichlorosilane by disproportionating trichlorosilane over a fixed catalyst bed, in which gaseous dichlorosilane is withdrawn and obtained under pressures between 0.8 and 1.2 bar and reactor temperatures between 10° C. and the boiling point of the reaction mixture which forms; proportions of trichlorosilane are condensed and recycled into the reactor, and some of the liquid reaction phase is withdrawn from the reactor and separated into tetrachlorosilane and trichlorosilane to be recycled into the reactor.

Combination of several successive reactions (2 to 5) makes possible the preparation of monosilane by the dismutation in three steps—proceeding from trichlorosilane to dichlorosilane, to monochlorosilane and finally to monosilane with formation of silicon tetrachloride:

2HSiCl₃⇄H₂SiCl₂+SiCl₄ (2)

2H₂SiCl₂⇄H₃SiCl+HSiCl₃ (3)

2H₃SiCl⇄SiH₄+H₂SiCl₂ (4)

4HSiCl₃⇄SiH₄+3SiCl₄ (5)

Monosilane is generally synthesized from trichlorosilane by dismutation, as described, for example, in patent documents DE 25 07 864, DE 33 11 650, DE 100 17 168.

The catalysts used for the dismutation are additionally typically ion exchangers, for example in the form of catalysts based on divinylbenzene-crosslinked polystyrene resin with tertiary amine groups, which is prepared by direct aminomethylation of a styrene-divinylbenzene copolymer (DE 100 57 521 A1), on solids which bear amino or alkyleneamino groups, for example dimethylamino groups, on a polystyrene framework crosslinked with divinylbenzene (DE 100 61 680 A1, DE 100 17 168 A1), catalysts which are based on anion-exchanging resins and have tertiary amino groups or quaternary ammonium groups (DE 33 11 650 A1), amine-functionalized inorganic supports (DE 37 11 444) or, according to DE 39 25 357, organopoly-siloxane catalysts such as N[(CH₂)₃SiO_{3/2}]₃. These can be introduced directly into the column, either as an undiluted bed (DE 25 07 864), in layers (DE 100 61 680 A1) or in a woven structure (WO 90/02603). Alternatively, the catalyst can be accommodated in one or more external reactors, in which case inlets and outlets are connected to different sites in the distillation column (DE 37 11 444). A plant for preparing silanes of the general formula HₙSiCl₄, where n=1, 2, 3 and/or 4 by dismutating more highly chlorinated silanes in the presence of a catalyst is disclosed by WO 2006/029930 A1. The plant comprises a distillation column with a column bottom, column top and a side reactor with a catalyst bed. The catalyst in the catalyst bed may correspond to a structured fabric packing or random packings made of fabric; alternatively, the catalyst bed may also comprise random packings or internals composed of catalytically active material.

Owing to the substance properties of the silanes involved (cf. Table 1) and the often very unfavorable position of the chemical equilibrium in the dismutation reaction, the reaction and the distillative workup are generally conducted in an integrated system.

TABLE 1.1
Substance data of chlorosilanes and monosilane

| | | Monochloro- | | | |
|---|---|---|---|---|---|
| Substance | Monosilane | silane | DCS | TCS | STC |
| Critical temp. [° C.] | −3.5 | 123 | 176 | 206 | 234 |
| Standard boiling | −112 | −30 | 8.3 | 31.8 | 57.1 |
| point [° C.] | | | | | |
| Boiling point at 5 | −78 | 15 | 60 | 87 | 117 |
| bar [° C.] | | | | | |
| Boiling point at 25 | −28 | 85 | 137 | 170 | 207 |
| bar [° C.] | | | | | |

The best possible integration of reaction and substance separation is offered by reactive rectification, because the dismutation reaction is a reaction whose conversion is limited by the chemical equilibrium. This fact necessitates the removal of reaction products from the unconverted reactants in order ultimately to drive the conversion in the overall process to completeness.

When distillation is selected as a separating operation, which is an option owing to the position of the boiling points (cf. Table 1.1), the energetically ideal apparatus would be an infinitely high distillation column in which a suitable catalyst or as long a residence time as necessary ensures the attainment of chemical equilibrium at each plate or at each theoretical plate. This apparatus would have the lowest possible energy demand and hence the lowest possible operating costs [cf. FIG. 6 and Sundmacher & Kienle (Eds.), “Reactive Destillation”, Verlag Wiley-VCH, Weinheim 2003].

As described at the outset, DE 37 11 444 A1 discloses amine-functionalized catalysts on inorganic supports for preparation of dichlorosilane (DCS) from trichlorosilane by means of dismutation. The (CH₃CH₂O)₃Si(CH₂)₃N(octyl)₂ and (CH₃O)₃Si(CH₂)₃N(C₂H₅)₂ catalysts listed do not have a high activity, such that the catalyst has to be used in comparatively large amounts. The mention of the compound (CH₃O)₃Si(CH₂)₂N(C₄H₉)₂ also appears to have been rather coincidental, said compound, however, being obtainable synthetically only with extreme difficulty and being difficult to handle owing to the ethylenic —(CH₂)₂— structural element, from which ethylene (CH₂CH₂) can be eliminated (W. Noll, Chemie and Technologie der Silicone, p. 133 ff., Verlag Chemie Weinheim Bergstr., 1968).

It is an object of the present invention to provide a catalyst system for dismutating hydrogen-containing halosilanes, which does not have the disadvantages mentioned and enables a more economically viable process for preparing more highly hydrogenated hydrogen-containing halosilanes.

The object is achieved by an inventive catalyst for dismutating hydrogen- and halogen-containing silicon compounds, which comprises a support material and at least one linear, cyclic, branched and/or crosslinked aminoalkyl-functional siloxane and/or silanol, wherein at least one siloxane or silanol in idealized form is of the general formula II

(R²)[—O—(R⁴)Si(A)]ₐR³.(HW)_{w} (II)

where A is an aminoalkyl radical —(CH₂)₃—N(R¹)₂, R¹ is the same or different and is an isobutyl, n-butyl, tert-butyl and/or cyclohexyl group, R² is independently hydrogen, a methyl, ethyl, n-propyl, isopropyl group, and/or Y and R³ and R⁴ are each independently a hydroxyl, methoxy, ethoxy, n-propoxy, isopropoxy, methyl, ethyl, n-propyl, isopropyl group and/or —OY where Y represents the support material, HW is an acid where W is an inorganic or organic acid radical, where a≧1 for a silanol, a≧2 for a siloxane and w≧0. More particularly, the inventive catalyst comprises at least one siloxane or silanol with an aminoalkyl radical selected from 3-(N,N-di-n-butylamino)propyl, 3-(N,N-di-tert-butylamino)propyl and/or 3-(N,N-diisobutyl-amino)propyl radical. In the presence of cyclic, branched and/or crosslinked siloxanes or silanols, siloxane bonds (—O—Si—O—) were formed, for example, by condensation of at least two of the original —OR², R³ and/or R⁴ groups. As evident from the working examples, these catalysts allow a considerably more rapid establishment of the equilibrium position in the dismutation reactions.

It should be noted that particular demands are made on the catalyst for dismutation of silicon compounds, especially when the silicon compound corresponds to the general formula (III) HₙSiₘX₍2m+2−n) where X is independently fluorine, chlorine, bromine and/or iodine and 1≦n<(2m+2) and 1≦m≦12, preferably 1≦m≦6, the silicon compound more preferably being at least one of the compounds HSiCl₃, H₂SiCl₂ and/or H₃SiCl.

In order to be able to prepare and obtain high-purity or ultra-high-purity silicon compounds, a catalyst must be absolutely anhydrous and/or free of alcohols. High-purity silicon compounds are those whose degree of contamination is in the ppb range; ultra-high-purity are understood to mean impurities in the ppt range and lower. Contamination of silicon compounds with other metal compounds should be no higher than in the ppb range down to the ppt range, preferably in the ppt range. The required purity can be checked by means of GC, IR, NMR, ICP-MS, or by resistance measurement or GD-MS after deposition of the silicon.

A suitable support material (Y) is in principle any porous or microporous material, preference being given to using silicon dioxide (SiO₂) or else zeolites, which may additionally also contain aluminum, iron, titanium, potassium, sodium, calcium and/or magnesium. According to the composition and/or preparation process, the silicon dioxide may have acidic, neutral or basic character. The support material is in particulate form and can be used, for example, in the form of shaped bodies, such as spheres, pellets, rings, extruded rod-shaped bodies, trilobes, tubes, honeycomb, etc., or in the form of grains, granules or powder, preference being given to spheres or pellets. The supported catalyst is preferably based on a microporous support with a pore volume of 100 to 1000 mm³/g and a BET surface area of 10 to 500 m²/g, preferably 50 to 400 m²/g, more preferably 100 to 200 m²/g. The person skilled in the art can determine the pore volume and the BET surface area by means of methods known per se. The support material preferably has a geometric surface area of 100 to 2000 m²/m³ and a bulk volume of 0.1 to 2 kg/I, preferably of 0.2 to 1 kg/l, more preferably 0.4 to 0.9 kg/l. The ready-to-use supported catalyst should suitably be absolutely free of water, solvents and oxygen, and should also not release these substances in the course of heating.

The content of aminoalkylalkoxysilane compound used to modify or impregnate the support material in the course of preparation of the catalyst is preferably 0.1 to 40% by weight based on the amount of support. Preference is given to contents of 1 to 25% by weight, more preferably 10 to 20% by weight, based on the support material.

The aminoalkyl-functional siloxane or silanol which has been deposited on the support or condensed with the support material and advantageously thus attached covalently via Y—O—Si, and is of the general formula (II)

(R²)[—O—(R⁴)Si(A)]ₐR³.(HW)_{w} (II),

is preferably deposited from a solvent as a compound which is basic owing to the amino group; it may optionally react with support material to give a salt, in which case HW corresponds to an acidic support material, for example in the case of silica-containing support materials. Alternatively, the aminoalkyl-functional siloxane or silanol can also be deposited as the ammonium salt from a solvent, for example as the hydrohalide, such as hydrochloride. In a further alternative, it can also be deposited with a carboxylate or sulfate as the counterion.

The invention further provides a process for preparing the inventive catalysts, and catalysts obtainable by the process, in which a support material and at least one alkoxysilane of the general formula I

R²—O—(R⁴)Si(A)-R³ (I)

where A is an aminoalkyl radical —(CH₂)₃—N(R¹)₂ and R¹ is the same or different and is an isobutyl, n-butyl, tert-butyl and/or cyclohexyl group, R² is hydrogen, a methyl, ethyl, n-propyl or isopropyl group, and R³ and R⁴ are each independently a hydroxyl, methoxy, ethoxy, n-propoxy, isopropoxy, methyl, ethyl, n-propyl and/or isopropyl group,
are hydrolyzed and optionally condensed in the presence of water and/or of a solvent and optionally with addition of an acid, and the alcohol already present or formed in the reaction is removed. In this process, the alkoxysilane is advantageously attached in a fixed manner to the support material. Preferred solvents are aqueous alcohols for hydrolysis, which are, for example, methanol, ethanol, isopropanol with a water content which is especially in the range from 0.5 to 30% by weight, preferably in the range from 0.5 to 10% by weight, more preferably in the range from 1 to 5% by weight. Based on the alkoxysilyl groups present, advantageously 0.5 to 50 mol of water, especially 1 to 20 mol of water, are used, i.e. added in the course of hydrolysis. Generally, suitable solvents are all of those in which the compound of the formula I and/or the process product is soluble. Particular preference is given to hydrolyzing and/or condensing in aqueous ethanolic solution. The reaction can be effected at temperatures between 0 and 150° C., under standard pressure or reduced pressure, preferably at 1 to 1000 mbar, more preferably at 50 to 800 mbar, especially at 100 to 500 mbar, the reaction preferably being effected in the heat of boiling.

According to the invention, at least one alkoxysilane selected from the group of 3-(N,N-di-n-butylamino)propyltrimethoxysilane, 3-(N,N-di-n-butylamino)propyltriethoxy-silane, 3-(N,N-di-tert-butylamino)propyltrimethoxysilane, 3-(N,N-di-tert-butylamino)-propyltriethoxysilane, 3-(N,N-diisobutylamino)propyltrimethoxysilane or 3-(N,N-diisobutylamino)propyltriethoxysilane is reacted in the presence of a support material, the support material preferably being based on silicon dioxide particles. Further appropriate alkoxysilanes of the general formula (I) may have the following substituents: where R₁ is an isobutyl, n-butyl or tert-butyl group, R² is a methyl, ethyl, n-propyl or isopropyl group, and R⁴ and R³ are each a methoxy, ethoxy, n-propoxy and/or isopropoxy group.

As detailed at the outset, the ready-to-use inventive catalyst for preparing high-purity or ultra-high-purity silicon compounds must be absolutely anhydrous and/or free of alcohols. To this end, the coated catalyst support is advantageously dried to constant weight. With regard to the requirements and advantageous properties of the support material for preparing the catalysts, reference is made to the above remarks.

The inventive catalyst is employed in the dismutation of hydrogen- and halogen-containing silicon compounds, especially of halosilanes such as trichlorosilane, which can react to give dichlorosilane, monosilane, monochlorosilane and tetrachlorosilane.

The invention also provides a process for dismutating hydrogen- and halogen-containing silicon compounds over the inventive aminoalkyl-functional catalyst present in a reactor, wherein the catalyst composed of a support material and at least one linear, cyclic, branched and/or crosslinked siloxane and/or silanol is contacted with a hydrogen- and halogen-containing silicon compound, wherein at least one siloxane or silanol in idealized form is of the general formula II

(R²)[—O—(R⁴)Si(A)]ₐR³.(HW)_{w} (II)

where A is an aminoalkyl radical —(CH₂)₃—N(R¹)₂, R¹ is the same or different and is an isobutyl, n-butyl, tert-butyl and/or cyclohexyl group, R² is independently hydrogen, a methyl, ethyl, n-propyl, isopropyl group, or Y and R³ and R⁴ are each independently a hydroxyl, methoxy, ethoxy, n-propoxy, isopropoxy, methyl, ethyl, n-propyl, isopropyl group and/or —OY where Y represents the support material, HW is an acid where W is an inorganic or organic acid radical, where a≧1 for the silanol, a≧2 for the siloxane and w≧0, and wherein at least a portion of the reaction mixture formed is worked up. A preferred catalyst comprises siloxanes and/or silanols with at least one of the following aminoalkyl radicals A: 3-(N,N-di-n-butylamino)propyl, 3-(N,N-di-tert-butylamino)propyl and/or 3-(N,N-diisobutylamino)propyl groups, the siloxanes and/or silanols having been prepared in the presence of a support material which is preferably based on the silicon dioxide described at the outset. The most favorable form of support material can be selected according to reaction regime and reactor. In the process according to the invention, the catalyst is subjected in a reactor to a continuous flow of at least one silicon compound which is to be dismutated and is of the general formula III HₙSiₘX₍₂ₘ₊₂₋ₙ₎, where X is independently fluorine, chlorine, bromine and/or iodine, and 1≦n≦(2m+2) and 1≦m≦12, preferably 1≦m≦6, particular preference being given to converting trichlorosilane to dichlorosilane, monochlorosilane and monosilane, which are subsequently removed. The silicon tetrachloride which is likewise formed is withdrawn discontinuously or continuously from the chemical equilibrium and can be purified separately. The catalyst is preferably present in a catalyst bed. The halosilanes can be removed by means of a column assigned to the reactor, which may, for example, be connected directly to the reactor. In the case of use of a column for distillative removal and purification of at least a portion of the reaction mixture formed, more highly hydrogenated silicon compounds can be obtained as low boilers at the top of the column, and more highly chlorinated silicon compounds can be enriched as high boilers in a collecting vessel, while at least one unconverted silicon compound can be obtained as medium boilers in the column and returned to the assigned reactor.

In a particularly preferred procedure, the catalyst in a catalyst bed in a reactor is assigned to each plate of a column, for example of a rectification column.

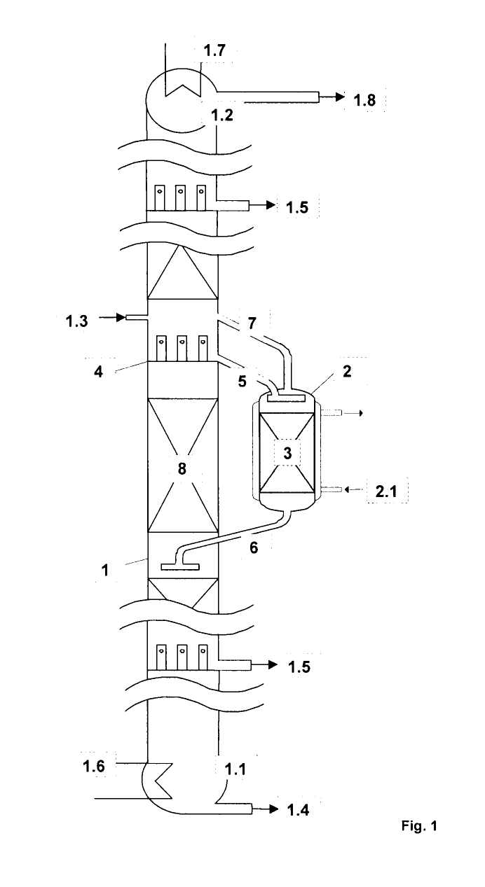

The invention likewise provides a plant for dismutating hydrogen- and halogen-containing silicon compounds, as shown, for example, in FIG. 1. This plant comprises an inventive catalyst composed of a support material with siloxanes and/or silanols, based on the reaction of an aminoalkylalkoxysilane of the general formula I, especially on siloxanes and/or silanols of the general formula II, wherein the plant is based on at least one distillation column (1) with a column bottom (1.1) and a column top (1.2), at least one side reactor (2) with a catalyst bed (3), at least one reactant introduction point (1.3), a product withdrawal point (1.4) and at least one further product withdrawal point (1.5 or 1.8), wherein the distillation column (1) is equipped with at least one chimney tray (4) and at least one side reactor (2) is connected to the distillation column (1) via at least three pipelines (5, 6, 7) in such a way that the transition of the line (5) into the distillation column (1) for the discharge of the condensate from the chimney tray (4) is higher than the upper edge of the catalyst bed (3), the line (6) for the discharge of the liquid phase from the side reactor (2) opens into the distillation column (1) below the chimney tray (4), and this opening (6) is lower than the upper edge of the catalyst bed (3), and the line (7) for the discharge of the gas phase from the corresponding side reactor (2) opens into the distillation column (1) above the plane of the chimney tray (4), the column bottom being heatable (1.6, 1.1) and the column being coolable (1.7) (see FIG. 1).

The startup or filling of the plant with more highly chlorinated silanes as the reactant, especially with trichlorosilane, and also the reactant supply during the operation of the plant, can be effected, for example, via feed lines or taps at the reactant introduction point (1.3) and/or via the column bottom (1.1). Products can be withdrawn via the top of the column (1.8), the withdrawal point (1.5) and/or the column bottom (1.4). The catalyst in the catalyst bed (3) may be in the form of random packings, which may be present, for example, as a bed or as pressed shaped bodies.

The plant can advantageously be equipped with a heatable column bottom (1.6, 1.1) and a low-temperature cooling system (1.7) in the column top (1.2). In addition, the column (1) may be equipped with at least one column packing (8), and possess at least one additional reactant introduction point (1.3) or product withdrawal point (1.5).

The catalyst bed of a side reactor is preferably operated at a temperature of −80 to 120° C., the reactor or catalyst bed temperature advantageously being regulable or controllable (2.1) by means of a cooling or heating jacket of the reactor. In general, the plant is operated in accordance with the process according to the invention in the presence of a catalyst at a temperature in the range from −120 to 180° C. and a pressure of 0.1 to 30 bar abs.

Even though a sufficiently long residence time over the catalyst, i.e. a sufficiently low catalyst velocity for the approximate attainment of chemical equilibrium, has to be ensured for the relatively slow dismutation reaction, the use of the inventive catalyst allows the dimensions of the reactor to be smaller than conventional reactors for comparable product streams. The dimensions of the usable reactors (2) should be such that 80 to 98% of the equilibrium conversion is attainable.

The silicon compounds prepared by the process according to the invention, dichlorosilane, monochlorosilane and/or monosilane, have high purity to ultra-high purity and are particularly suitable as precursors for preparing silicon nitride, silicon oxynitride, silicon carbide, silicon oxycarbide or silicon oxide, and as precursors for generating epitactic layers.

The preparation of the catalyst and also the mode of action thereof are illustrated in detail by the examples which follow, without restricting the invention to these examples.

### EXAMPLES

### Example 1

600 g of hydrous ethanol (H₂O content about 5%) and 54 g of 3-(N,N-diethylamino)-propyltrimethoxysilane were initially charged with 300 g of support material (SiO₂ spheres, Ø 5 mm, BET 150 m²/g, bulk density: 0.55 g/cm³). The reaction mixture was heated under reflux for 5 hours. After cooling, the supernatant liquid was filtered off with suction, and the spheres were washed with 600 g of anhydrous ethanol. After one hour, the liquid was filtered off with suction again. Subsequently, the SiO₂ spheres were predried at a pressure of 300 to 30 mbar and a bath temperature of 110 to 120° C. for one hour, and then dried at <1 mbar for 9.5 hours.

### Example 2

### 600 g of hydrous ethanol (H₂O content about 5%) and 54 g of 3-(N,N-n-dibutylamino)propyltrimethoxysilane were initially charged with 300 g of support material (SiO₂ spheres, Ø 5 mm, BET 150 m²/g, bulk density: 0.55 g/cm³). The reaction mixture was heated under reflux for 5 hours. After cooling, the supernatant liquid was filtered off with suction, and the spheres were washed with 600 g of anhydrous ethanol. After one hour, the liquid was filtered off with suction again. Subsequently, the SiO₂ spheres were predried at a pressure of 300 to 30 mbar and a bath temperature of 110 to 120° C. for one hour, and then dried at <1 mbar for 9.5 hours.

### Example 3

600 g of hydrous ethanol (H₂O content about 5%) and 54 g of 3-(N,N-diisobutylamino)propyltrimethoxysilane were initially charged with 300 g of support material (SiO₂ spheres, Ø 5 mm, BET 150 m²/g, bulk density: 0.55 g/cm³). The reaction mixture was heated under reflux for 5 hours. After cooling, the supernatant liquid was filtered off with suction, and the spheres were washed with 600 g of anhydrous ethanol. After one hour, the liquid was filtered off with suction again. Subsequently, the SiO₂ spheres were predried at a pressure of 300 to 30 mbar and a bath temperature of 110 to 120° C. for one hour, and then dried at <1 mbar for 9.5 hours.

### Example 4

600 g of hydrous ethanol (H₂O content about 5%) and 54 g of 3-(N,N-dicyclohexylamino)propyltrimethoxysilane were initially charged with 300 g of support material (SiO₂ spheres, Ø 5 mm, BET 150 m²/g, bulk density: 0.55 g/cm³). The reaction mixture was heated under reflux for 5 hours. After cooling, the supernatant liquid was filtered off with suction, and the spheres were washed with 600 g of anhydrous ethanol. After one hour, the liquid was filtered off with suction again. Subsequently, the SiO₂ spheres were predried at a pressure of 300 to 30 mbar and a bath temperature of 110 to 120° C. for one hour, and then dried at <1 mbar for 9.5 hours.

### Example 5

600 g of hydrous ethanol (H₂O content about 5%) and 54 g of 3-(N,N-dioctylamino)-propyltrimethoxysilane were initially charged with 300 g of support material (SiO₂ spheres, Ø 5 mm, BET 150 m²/g, bulk density: 0.55 g/cm³). The reaction mixture was heated under reflux for 5 hours. After cooling, the supernatant liquid was filtered off with suction, and the spheres were washed with 600 g of anhydrous ethanol. After one hour, the liquid was filtered off with suction again. Subsequently, the SiO₂ spheres were predried at a pressure of 300 to 30 mbar and a bath temperature of 110 to 120° C. for one hour, and then dried at <1 mbar for 9.5 hours.

### Example 6

300 g of untreated support material (SiO₂ spheres, Ø 5 mm, BET 150 m²/g, bulk density: 0.55 g/cm³) were dried at a bath temperature of 110 to 119° C. at a pressure of 300 to 30 mbar for one hour, and then at <1 mbar for about 9.5 hours.

### Comparative Examples

### Determination of Catalyst Activity

In the comparative examples which follow, 48 g in each case of the silicon dioxide spheres of Examples 1 to 6 coated with aminoalkylsiloxanes and/or aminoalkylsilanols were initially charged in a 300 ml round-bottomed flask with a low-temperature condenser, outlet tap and protective gas blanketing under protective gas (nitrogen). Subsequently, 100 ml of trichlorosilane were added and the mixture was left to stand at room temperature (20 to 25° C.). Under a protective gas atmosphere, samples were taken after 1, 2 and 4 hours, and were analyzed by means of GC analysis. Table 1 reproduces the dichlorosilane contents in area percent. It is possible to particularly rapidly establish the equilibrium position of the dismutation reaction with the catalysts from Examples 2 and 3 (3-N,N-di-n-butylaminopropyl and 3-N,N-diisobutylaminopropyl-substituted siloxane and/or silanol). The comparative examples used were the uncoated catalyst material from Example 6 and Example 1, in which a 3-(N,N-diethylamino)propyltrimethoxysilane known from the prior art was fixed to a support.

TABLE 1
Analysis results

| | Cat. | Cat. | Cat. | Cat. | Cat. | Cat. |
|---|---|---|---|---|---|---|
| Reaction | from | from | from | from | from | from |
| time [h] | Ex. 1 | Ex. 2 | Ex. 3 | Ex. 4 | Ex. 5 | Ex. 6 |
| 1 | 3.3 | 5.6 | 6.5 | 5.5 | 4.3 | 0.0 |
| 2 | 4.9 | 7.2 | 7.4 | 6.6 | 5.8 | 0.0 |
| 4 | 6.6 | 8.3 | 8.5 | 8.0 | 7.5 | 0.0 |

The comparative examples demonstrate clearly that the inventive catalyst is capable of establishing the desired short residence times of the trichlorosilane over the catalyst. Short residence times are desired especially in the case of a continuous process regime.

### Durability of the Catalyst:

The catalyst prepared according to Example 3 was subjected to prolonged operation over several months and its activity was tested. In addition, the prolonged operation was interrupted, and the catalyst bed was dried and put back into operation. The determination of the conversion rates showed a uniform activity of the catalyst.

1. A catalyst, comprising:
a support material and at least one linear, cyclic, branched and/or crosslinked aminoalkyl-functional siloxane and/or silanol, wherein at least one siloxane or silanol in idealized form is of the general represented by formula II
(R²)[—O—(R⁴)Si(A)]ₐR³.(HW)_{w} (II)
where A is an aminoalkyl radical —(CH₂)₃—N(R¹)₂, R¹ is the same or different and is an isobutyl, n-butyl, tert-butyl and/or cyclohexyl group, R² is independently hydrogen, methyl, ethyl, n-propyl, isopropyl group, and/or Y and R³ and R⁴ are each independently a hydroxyl, methoxy, ethoxy, n-propoxy, isopropoxy, methyl, ethyl, n-propyl, isopropyl group and/or —OY where Y represents the support material, HW is an acid where W is an inorganic or organic acid radical, where a≧1 for a silanol, a≧2 for a siloxane and w≧0.

2-3. (canceled)

4. A catalyst according to claim 1, wherein
the siloxane and/or silanol has at least one aminoalkyl radical comprising 3-(N,N-di-n-butylamino)propyl, 3-(N,N-di-tert-butylamino)propyl and/or 3-(N,N-diisobutylamino)propyl radical.

5. A catalyst according to claim 1, wherein
the support material comprises SiO₂ and/or a zeolite.

6. A catalyst according to claim 1, wherein
W is a halide, a silicic acid radical, a sulfate and/or a carboxylate.

7. A process for preparing a catalyst according to claim 1, comprising hydrolyzing and optionally condensing
a support material and at least one alkoxysilane represented by formula I
R²—O—(R⁴)Si(A)-R³ (I)
where A is an aminoalkyl radical —(CH₂)₃—N(R¹)₂ and R¹ is the same or different and is an isobutyl, n-butyl, tert-butyl and/or cyclohexyl group, R² is hydrogen, a methyl, ethyl, n-propyl or isopropyl group, and R³ and R⁴ are each independently a hydroxyl, methoxy, ethoxy, n-propoxy, isopropoxy, methyl, ethyl, n-propyl and/or isopropyl group,
in the presence of water and/or of a solvent, and
removing the alcohol already present or formed in the reaction.

8. A process according to claim 7, wherein
R¹ in the alkoxysilane is an isobutyl, n-butyl or tert-butyl group, R² is a methyl, ethyl, n-propyl or isopropyl group, and R⁴ and R³ are each a methoxy, ethoxy, n-propoxy and/or isopropoxy group.

9. A process according to claim 7, wherein
the alkoxysilane is 3-(N,N-di-n-butylamino)propyltrimethoxysilane, 3-(N,N-di-n-butylamino)propyltriethoxysilane, 3-(N,N-di-tert-butylamino)propyltrimethoxysilane, 3-(N,N-di-tert-butylamino)propyltriethoxysilane, 3-(N,N-diisobutylamino)-propyltrimethoxysilane or 3-(N,N-diisobutylamino)propyltriethoxysilane.

10. A process according to claim 7, wherein
0.5 to 50 mol of water, based on the alkoxysilyl groups, is present in the hydrolysis.

11. A process according to claim 7, wherein
the reaction is performed in the range from 0 to 150° C.

12. A process according to claim 7, wherein
the catalyst is dried to constant weight.

13. A process according to claim 7, wherein
the support material comprises SiO₂ particles or SiO₂ shaped bodies.

14. A catalyst obtained according to claim 7.

15. A process comprising the catalyst of claim 1, comprising dismutating hydrogen- and halogen-containing silicon compounds.

16. A process, comprising
dismutating a silicon compound comprising hydrogen and at least one halogen in the presence of a catalyst in a reactor
wherein said reactor comprises a support material and at least one linear, cyclic, branched and/or crosslinked aminoalkyl-functional siloxane and/or silanol is contacted with a hydrogen- and halogen-containing silicon compound,
wherein at least one siloxane or silanol in idealized form is represented by formula II
(R²)[—O—(R⁴)Si(A)]ₐR³.(HW)_{w} (II)
where A is an aminoalkyl radical —(CH₂)₃—N(R¹)₂, R¹ is the same or different and is an isobutyl, n-butyl, tert-butyl and/or cyclohexyl group, R² is independently hydrogen, a methyl, ethyl, n-propyl, isopropyl group, or Y and R³ and R⁴ are each independently a hydroxyl, methoxy, ethoxy, n-propoxy, isopropoxy, methyl, ethyl, n-propyl, isopropyl group and/or —OY where Y represents the support material, HW is an acid where W is an inorganic or organic acid radical, where a≧1 for the silanol, a≧2 for the siloxane and w≧0, and
working up at least a portion of the reaction mixture formed.

17. A process according to claim 16, further comprising
subjecting the catalyst in a reactor to a continuous flow of at least one silicon compound which is to be dismutated and is represented by formula III
HₙSiₘX₍₂ₘ₊₂₋ₙ₎ (III)
where X is independently fluorine, chlorine, bromine and/or iodine, and 1≦n<(2m+2) and 1≦m≦12.

18. A process according to claim 16, wherein
the silicon compound is trichlorosilane.

19. A process according to claim 16, further comprising obtaining
dichlorosilane, monochlorosilane and/or monosilane.

20. A process according to claim 16, wherein
the reactor comprises at least one column comprising at least one plate.

21. A process according to claim 16, wherein the working up comprises the distillation of
at least a portion of the reaction mixture formed, by obtaining more highly hydrogenated silicon compounds as low boilers at the top of the column, enriching more highly chlorinated silicon compounds as high boilers in a collecting vessel, and obtaining at least one unconverted silicon compound as a medium boiler in the column and returning it to the assigned reactor.

22. A process according to claim 20, wherein
the catalyst is assigned to each plate of the column.

23. A plant for dismutating hydrogen- and halogen-containing silicon compounds, comprising
a catalyst according to claim 1,
at least one distillation column comprising a column bottom and a column top,
at least one side reactor comprising a catalyst bed comprising an upper edge and a lower edge,
at least one reactant introduction point, and
at least a first and a second product withdrawal point,
wherein the distillation column comprises at least one chimney tray comprising a plane at its base and at least one side reactor connected to the distillation column via a liquid-phase discharge pipeline, a gas-phase discharge pipeline, and at least a third pipeline, wherein the third pipeline discharges condensate from the chimney tray of the distillation column to a point above the upper edge of the catalyst bed, the liquid-phase discharge pipeline from the side reactor comprises an opening into the distillation column below the chimney tray, and said opening is lower than the upper edge of the catalyst bed, and the gas phase gas-phase discharge pipeline from a corresponding side reactor opens into the distillation column above the plane of the chimney tray, the column bottom being heatable and the column being coolable.

24. The process according to claim 7, further comprising using an acid.
